(19) United States
(12) Patent Application Publication
(10) Pub. No.: US 2025/0167957 A1
(43) Pub. Date: May 22, 2025

(54) METHOD AND APPARATUS FOR SENDING SRSS, METHOD AND APPARATUS FOR RECEIVING SRSS, DEVICE, MEDIUM AND PRODUCT

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/843,136

(22) PCT Filed: Mar. 3, 2022
(86) PCT No.: PCT/CN2022/079157

§ 371 Date: Aug. 30, 2024

(51) Int. Cl. H04L 5/00; H04W 72/0453

(52) U.S. Cl. CPC H04L 5/0051; H04L 5/0016; H04W 72/0453

(57) ABSTRACT

A method for sending an SRS, includes: receiving configuration information of an SRS resource, where the SRS resource includes eight antenna ports; and mapping the SRS resource onto a physical resource corresponding to a configured transmission comb, and by respectively applying an orthogonal cover code (OCC) to different SRS basic port sequences, generating and sending SRSs of the eight antenna ports.

### CROSS-REFERENCE

The present application is a U.S. National Stage of International Application No. PCT/CN2022/079157, filed on Mar. 3,2022, the contents of all of which are incorporated herein by reference in their entireties for all purposes.

### BACKGROUND OF THE INVENTION

In a 5G new radio system, an uplink sounding reference signal (SRS) may be used to measure and estimate the channel quality of an uplink channel.

### SUMMARY OF THE INVENTION

The disclosure relates to the field of communications, in particular to a method and apparatus for sending an SRS, a method and apparatus for receiving an SRS, a device, a medium, and a product.

Examples of the disclosure provide a method and apparatus for sending an SRS, a method and apparatus for receiving an SRS, a device, a medium, and a product. The technical solution is as follows.

According to one aspect of the examples of the disclosure, a method for sending an SRS is provided, and the method is performed by a terminal, and includes: receiving configuration information of an SRS resource, where the SRS resource includes 8 antenna ports; and mapping the SRS resource onto a physical resource corresponding to a configured transmission comb, and generating and sending SRSs of the 8 antenna ports by respectively applying an orthogonal cover code (OCC) to different SRS basic port sequences.

According to another aspect of the examples of the disclosure, a method for receiving an SRS is provided, and the method is performed by a network device, and includes: sending configuration information of an SRS resource, where the SRS resource includes 8 antenna ports; and on a physical resource corresponding to a transmission comb, simultaneously receiving SRSs of the 8 antenna ports which are generated by respectively applying OCC to different SRS basic port sequences and sent.

According to another aspect of the examples of the disclosure, a terminal is provided, and the terminal includes: one or more processors; and one or more transceivers connected with the one or more processors. Where the one or more processors are configured to: receive configuration information of an SRS resource, where the SRS resource comprises 8 antenna ports; and map the SRS resource onto a physical resource corresponding to a configured transmission comb, and generate and send SRSs of the 8 antenna ports by respectively applying an orthogonal cover code (OCC) to different SRS basic port sequences.

According to another aspect of the examples of the disclosure, a network device is provided, and the network device includes: one or more processors; and one or more transceivers connected with the one or more processors. Where the one or more processors are configured to load and execute executable instructions to implement the method for receiving an SRS described in respective aspects.

It is to be understood that the above general descriptions and later detailed descriptions are merely exemplary and illustrative, and cannot limit the disclosure.

### BRIEF DESCRIPTION OF DRAWINGS

In order to explain the technical solution in examples of the disclosure more clearly, the accompanying drawings that need to be used in the description of the examples will be briefly introduced below. Apparently, the accompanying drawings in the following description are merely some examples of the disclosure, and for those of ordinary skill in the art, on the premise of no creative labor, other accompanying drawings can also be obtained according to these accompanying drawings.

FIG. 1 is a schematic structural diagram of a communication system shown according to an example.

FIG. 2 is a flow diagram of a method for sending an SRS shown according to an example.

FIG. 3 is a schematic diagram of mapping of an SRS resource shown according to an example.

FIG. 4 is a flow diagram of a method for sending an SRS shown according to another example.

FIG. 5 is a schematic diagram of mapping of an SRS resource shown according to another example.

FIG. 6 is a schematic diagram of mapping of an SRS resource shown according to another example.

FIG. 7 is a schematic diagram of mapping of an SRS resource shown according to another example.

FIG. 8 is a flow diagram of a method for sending an SRS shown according to another example.

FIG. 9 is a schematic diagram of mapping of an SRS resource shown according to another example.

FIG. 10 is a schematic diagram of mapping of an SRS resource shown according to another example.

FIG. 11 is a schematic diagram of mapping of an SRS resource shown according to another example.

FIG. 12 is a schematic diagram of mapping of an SRS resource shown according to another example.

FIG. 13 is a flow diagram of a method for receiving an SRS shown according to an example.

FIG. 14 is a block diagram of an apparatus for sending an SRS shown according to an example.

FIG. 15 is a block diagram of an apparatus for receiving an SRS shown according to an example.

FIG. 16 is a schematic structural diagram of a terminal shown according to an example.

FIG. 17 is a schematic structural diagram of an access network device shown according to an example.

### DETAILED DESCRIPTION OF THE INVENTION

Examples will be described in detail here, and instances of the examples are shown in the accompanying drawings. When the following description refers to the accompanying drawings, unless otherwise indicated, the same numbers in different accompanying drawings indicate the same or similar elements. The implementations described in the following examples do not represent all implementations consistent with the disclosure. Rather, they are merely instances of apparatuses and methods consistent with some aspects of the disclosure as detailed in the appended claims.

During sending of the uplink SRS, a plurality of antenna ports may be configured for user equipment (UE), and the UE supports the sending of SRSs of 4 antenna ports to the maximum.

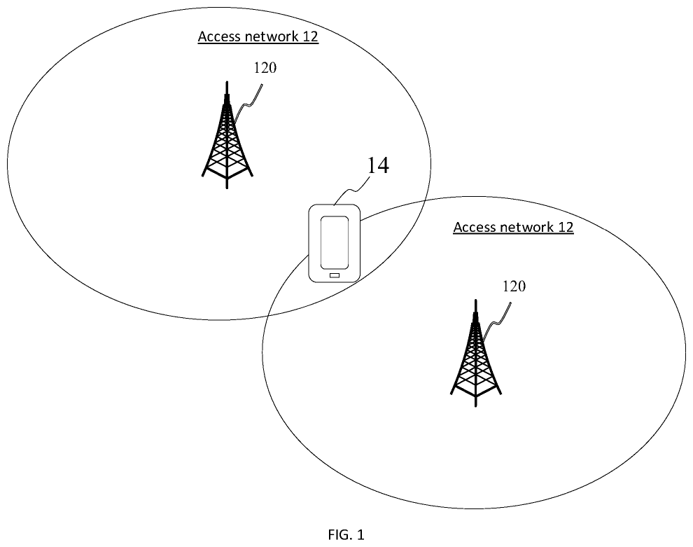

FIG. 1 shows a schematic structural diagram of a communication system 100 provided by an example of the disclosure. The communication system 100 may include: an access network 12 and a user terminal 14.

The access network 12 includes a plurality of network devices 120. The network devices 120 may be base stations, and the base stations are apparatuses deployed in an access network to provide a wireless communication function for the user terminal (for short, “terminal”) 14. The base stations may include various forms of macro base stations, micro base stations, relay stations, access points, etc. In systems adopting different wireless access techniques, devices having a base station function may be different in name, for example, in a long terminal evolution (LTE) system, the device is called eNodeB or eNB; and in a 5G new radio (NR) system, the device is called gNodeB or gNB. With the evolution of communication techniques, such description “base station” may vary. For the convenience of descriptions in examples of the disclosure, the apparatuses providing the wireless communication function for the user terminal 14 are collectively referred to as a network device.

The user terminal 14 may include various handheld devices, vehicle-mounted devices, wearable devices, computing devices or other processing devices, connected to wireless modems, having the wireless communication function, as well as various forms of user equipment, mobile stations (MSs), terminal devices, etc. For the convenience of description, the mentioned devices are collectively referred to as the user terminal. The network device 120 and the user terminal 14 communicate with each other through a certain radio technique, such as a Uu interface.

For example, there are two communication scenarios between the network device 120 and the user terminal 14: a uplink communication scenario and a downlink communication scenario. Uplink communication refers to sending a signal to the network device 120, and downlink communication refers to sending a signal to the user terminal 14.

The technical solution of the examples of the disclosure may be applied to various communication systems, such as: a global system of mobile communication (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolution system of an NR system, an LTE-based access to unlicensed spectrum (LTE-U) system, an NR Unlicensed (NR-U) system, a universal mobile telecommunication system (UMTS), a worldwide interoperability for microwave access (WIMAX) communication system, wireless local area networks (WLANs), wireless fidelity (WIFI), the next generation communication system or other communication systems.

In general, traditional communication systems support limited number of connections and are easy to implement. However, with the development of communication techniques, a mobile communication system will not only support traditional communication, but also, for example, device to device (D2D) communication, machine to machine (M2M) communication, machine type communication (MTC), vehicle to vehicle (V2V) communication, a vehicle to everything (V2X) system, etc. The examples of the disclosure may also be applied to these communication systems.

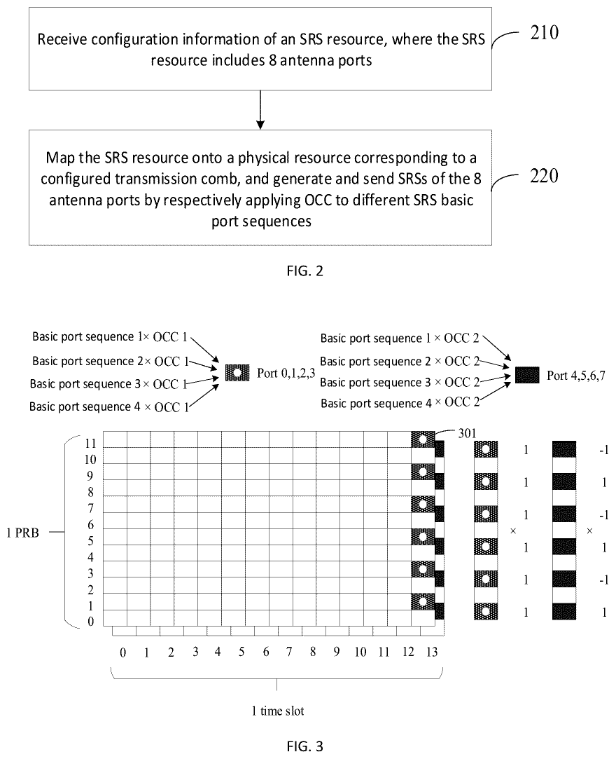

FIG. 2 shows a method flow diagram of a method for sending an SRS provided by an example of the disclosure. The method is performed by the terminal of the communication system shown in FIG. 1, and the method includes steps 210 and 220.

In step 210, configuration information of an SRS resource is received, where the SRS resource includes 8 antenna ports.

For example, the configuration information of the SRS resource sent by a network device is received by the terminal, and the configuration information is used to configure one SRS resource for the terminal.

The configured SRS resource includes 8 antenna ports. That is, the configuration information of the SRS resource includes: the quantity of the antenna ports of the SRS Nₐₚ^{SRS}=8; and port numbers of the 8 antenna ports Pᵢ=1000+i, i∈{0,1,2,3,4,5,6,7}.

Alternatively, the configured SRS resource includes at least two antenna port groups (i.e., N antenna port groups) corresponding to the 8 antenna ports. That is, the configuration information of the SRS resource includes: the quantity of the antenna ports of the SRS Nₐₚ^{SRS}=8; the quantity of antenna ports in each antenna port group being 8/N, where N=2 or 4; and port numbers of the 8 antenna ports Pᵢ=1000+i, i∈{0,1,2,3,4,5,6,7}. Alternatively, the configuration information of the SRS resource further includes: the quantity of the antenna ports of the SRS Nₐₚ^{SRS}=8; the quantity of antenna ports in each antenna port group being 8/N, where N=2 or 4; and port numbers of the 8/N antenna ports in each antenna port group.

Part or all of the configuration information of the SRS may be configured for the terminal by the network device, and/or, part or all of the configuration information of the SRS may be defined by a protocol. For example, the configuration information includes at least one of the following: a transmission comb parameter K_{TC}; a frequency domain offset value parameter k̅_{TC}; a bandwidth parameter; a cyclic shift parameter n_{SRS}^{cs}; the quantity of the antenna ports Nₐₚ^{SRS}; a time domain position of a transmission comb; a sequence length K of orthogonal cover codes (OCC); and/or the quantity of the antenna port groups N, or, the quantity of transmission combs N.

The transmission comb parameter is used to indicate a comb-like structure of the SRS resource on a frequency domain, that is, the SRS resource is not mapped on continuous sub-carriers. The transmission comb parameter is represented by comb, comb=K_{TC}, a value of K_{TC} is a positive integer, and adjacent sub-carriers in the SRS resource are spaced by (K_{TC}−1) sub-carriers, that is, adjacent resource element (RE) resources in the SRS resource are spaced by (K_{TC}−1) sub-carriers, for example, when comb=8, the adjacent RE resources in one SRS resource are spaced by 7 sub-carriers. The frequency domain offset value parameter refers to an offset value of sub-carriers occupied by the first RE resource in one SRS resource, and the frequency domain offset value parameter is a non-negative integer less than the transmission comb parameter. The bandwidth parameter refers to a frequency bandwidth occupied by the SRS resource. The cyclic shift parameter refers to the quantity of bits of cyclic shift of a sequence. An antenna port is a logic emission channel defined by a reference signal, and the antenna port is mapped onto a physical antenna for sending signals. The time domain position of the transmission comb is used to indicate a symbol occupied by the transmission comb on a time slot. The bandwidth parameter refers to a bandwidth of physical resource blocks (PRBs) occupied by the SRS resource.

For example, the configuration information may further include: a length of a ZC sequence. The length of the ZC sequence refers to a numeric length of the ZC sequence.

In step 220, the SRS resource is mapped onto a physical resource corresponding to a configured transmission comb, and SRSs of the 8 antenna ports are generated by respectively applying OCC to different SRS basic port sequences and sent.

When the terminal measures the quality of an uplink channel, one SRS resource is mapped onto the same physical resource (PR). For example, the physical resource refers to a continuous carrier resource on a frequency domain, where 1 physical resource block (PRB) corresponds to 12 continuous carriers on the frequency domain and 1 time slot on a time domain.

For example, the uplink channel includes: at least one of a physical uplink control channel (PUCCH), or a physical uplink shared channel (PUSCH). The terminal may map one SRS resource onto a physical resource of the PUCCH and/or the PUSCH.

For example, the terminal maps one SRS resource onto the same physical resource according to the configuration information, and the SRS resource includes 8 antenna ports; and SRSs of the 8 antenna ports are mapped onto a physical resource corresponding to a transmission comb, by respectively applying OCC to different SRS basic port sequences, the SRSs of the 8 antenna ports are generated by expansion based on at least one basic port sequence, and the SRSs of the 8 antenna ports are sent. For instance, 8 SRS sequences are generated by the terminal based on one basic port sequence and an OCC with a code length of 8, the SRSs of the 8 antenna ports are carried by the 8 SRS sequences, and the SRSs of the 8 antenna ports are sent. For example, 8° C. Cs, each OCC with a code length of 8, are shown in Table 1.

TABLE 1

| f1 | w_{f1}(k1) |
|---|---|
| 0 | [+1 +1 +1 +1 +1 +1 +1 +1] |
| 1 | [+1 +1 +1 +1 −1 −1 −1 −1] |
| 2 | [+1 +1 −1 −1 −1 −1 +1 +1] |
| 3 | [+1 +1 −1 −1 +1 +1 −1 −1] |
| 4 | [+1 −1 −1 +1 +1 −1 −1 +1] |
| 5 | [+1 −1 −1 +1 −1 +1 +1 −1] |
| 6 | [+1 −1 +1 −1 −1 +1 −1 +1] |
| 7 | [+1 −1 +1 −1 +1 −1 +1 −1] |

As shown in Table 1, f1 represents the serial number of the OCC, a value of f1 ranges from 0 to 7, representing a total of 8 OCCs. K1 is the code length of the OCC, and a value of K1 is 8. Further, w_{f1}(k1) is the f1^{th} OCC with the code length of K1.

For example, the basic port sequence includes a ZC sequence.

For example, the 8 antenna ports may be antenna ports that are mapped onto the same antenna panel or different antenna panels. That is, these 8 antenna ports are antenna ports that are mapped onto S antenna panels, where S is a positive integer less than or equal to 8. For instance, the first antenna port in these 8 antenna ports is mapped onto the first antenna panel, and the second antenna port in these 8 antenna ports is mapped onto the second antenna panel.

For example, the terminal makes one SRS resource occupy Q continuous orthogonal frequency-division multiplexing (OFDM) symbols, where Q={1,2,4}.

For example, a function of the SRS resource is at least one of the following: a codebook; antenna switching; or a non-codebook.

The terminal may perform codebook-based channel quality detection, or channel quality detection during antenna switching, or non-codebook-based channel quality detection.

For example, a value range of the transmission comb parameter K_{TC} is {2,4,8,12}. For instance, taking K_{TC}=² as an example, as shown in FIG. 3, the terminal maps one transmission comb 301 onto one PRB in a case that the transmission comb parameter is equal to 2 and a frequency domain offset value parameter of the transmission comb 301 is 1. Adjacent sub-carriers in the transmission comb 301 are spaced by 1 sub-carrier, and sub-carriers occupied by the transmission comb 301 include a sub-carrier 1, a sub-carrier 3, a sub-carrier 5, a sub-carrier 7, a sub-carrier 9, and a sub-carrier 11. The transmission comb 301 is located on a symbol 12 of one time slot and the terminal applies OCC with a code length of 2 to 4 basic port sequences (basic port sequences 1 to 4) respectively. SRSs of the 8 antenna ports are obtained by expansion, taking the expansion of the basic port sequence 1 as an example, if the basic port sequence 1 is [X1, X2, X3, X4, X5, X6], it is multiplied by OCC1 to obtain an SRS sequence of a port 0: [X1, X2, X3, X4, X5, X6], it is multiplied by OCC2 to obtain an SRS sequence of a port 4: [(−1)X1, X2, (−1)X3, X4, (−1)X5, X6], and so on, the OCC is applied to the 4 basic port sequences respectively, and SRS sequences of the 8 antenna ports are obtained by expansion. For example, each transmission comb resource (including an RE resource) of two transmission combs in FIG. 3 may occupy 1 OFDM symbol.

For example, a maximum value of the cyclic shift parameter of the transmission comb corresponding to the 8 antenna ports is n_{SRS}^{cs,max}; and a value range corresponding to the cyclic shift parameter n_{SRS}^{cs} configured for the 8 antenna ports is n_{SRS}^{cs} ∈ {0, 1, 2, . . . , n_{SRS}^{cs,max}−1}.

Alternatively, the quantity of the cyclic shift parameters supported by the transmission comb parameter to the maximum is 2, or 4, or 8, or 12, and a value range of n_{SRS}^{cs} is n_{SRS}^{cs} ∈ {0, 1, . . . , n_{SRS}^{cs,max}−1}; and thus all or part of the cyclic shift parameters in the cyclic shift parameters are used by the terminal to generate the SRS resource.

For instance, for 4 antenna ports, if the quantity of the cyclic shift parameters supported by the transmission comb parameter to the maximum is 8, then 4 of the 8 cyclic shift parameters are actually used by the terminal to generate the SRS resource. In another instance, for 8 antenna ports, if the quantity of the cyclic shift parameters supported by the transmission comb parameter to the maximum is 12, then 8 of the 12 cyclic shift parameters are actually used by the terminal to generate the SRS resource.

In other examples, in a case that the transmission comb parameter K_{TC} is equal to 2 or 4, the bandwidth parameter is greater than or equal to a bandwidth of 4 PRBs; or, the bandwidth parameter is a multiple of a bandwidth of 4 PRBs; the bandwidth parameter is greater than or equal to a bandwidth of 6 PRBs; or, the bandwidth parameter is a multiple of a bandwidth of 6 PRBs; or the bandwidth parameter is greater than or equal to a bandwidth of 8 PRBs; or the bandwidth parameter is a multiple of a bandwidth of 8 PRBs.

In a case that the transmission comb parameter K_{TC} is equal to 8 or 12, only one SRS resource can be mapped onto one PRB, and thus the bandwidth parameter is greater than or equal to a bandwidth of 6 PRBs; or, the bandwidth parameter is a multiple of a bandwidth of 6 PRBs; or the bandwidth parameter is greater than or equal to a bandwidth of 8 PRBs; or the bandwidth parameter is a multiple of a bandwidth of 8 PRBs. That is, a minimum bandwidth parameter configured for the SRS resource is 6 PRBs. In this way, a plurality of SRS resources can be mapped onto a plurality of PRBs, avoiding the situation that a measurement result of the quality of the uplink channel is not representative due to fewer SRS resources.

To sum up, in the method for sending an SRS provided by the present example, the SRS resource is mapped onto the physical resource corresponding to the configured transmission comb, and the SRSs of the 8 antenna ports are generated by respectively applying the OCC to the different SRS basic port sequences and sent. The method is used to support the realization of relevant functions in the case that 8 sending antenna ports are used by the terminal, for example, the method is used to support codebook-based channel quality detection in the case that the 8 sending antenna ports are used by the terminal, or to support non-codebook-based channel quality detection in the case that the 8 sending antenna ports are used by the terminal, or to support channel quality detection during antenna switching in the case that the 8 sending antenna ports are used by the terminal.

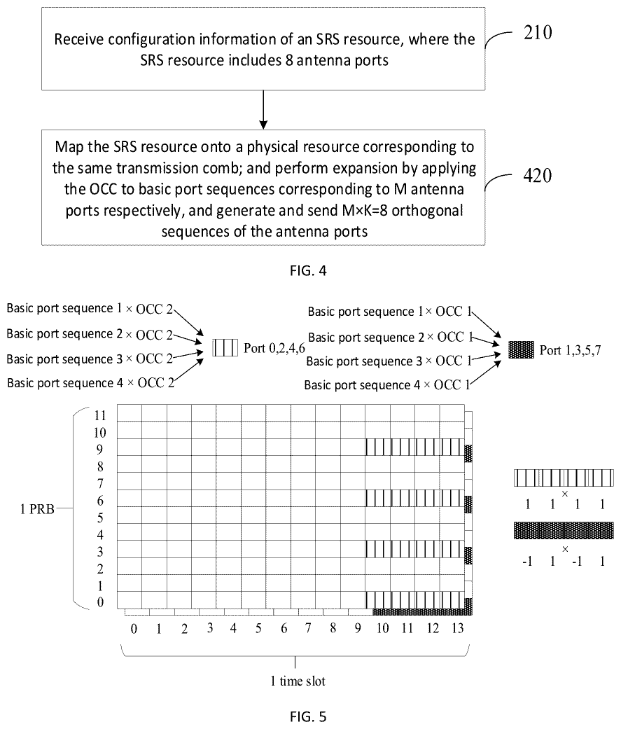

In some examples, the SRSs of the 8 antenna ports may be sent through the same transmission comb, and as shown in FIG. 4, step 220 of FIG. 2 may be implemented as follows by step 420.

In step 420, the SRS resource is mapped onto a physical resource corresponding to the same transmission comb; and expansion is performed by applying the OCC to basic port sequences corresponding to M antenna ports respectively, and M×K=8 orthogonal sequences of the antenna ports are generated and sent.

M is a positive integer not greater than 8, K is a sequence length of the OCC, and a value of K is 2, or 4 or 8. For example, as shown in FIG. 3, in a case that the value of K is 2, the terminal may map the SRSs of the 8 antenna ports onto the physical resource corresponding to the same transmission comb 301, perform expansion by applying OCC1 and OCC2 to basic port sequences corresponding to 4 antenna ports respectively, and generate and send 8 orthogonal sequences of the antenna ports.

When the SRSs are sent on the same transmission comb, the terminal may expand the basic port sequences of 1 or 2 or 4 antenna ports based on the OCC, so as to send the SRSs of the 8 antenna ports at the same time, where an expansion manner of the 8 antenna ports includes at least one of the first, second or third examples.

In the first example, in a case of K=2, expansion is performed by the terminal by applying the OCC to the basic port sequences corresponding to the 4 antenna ports respectively, and 4×2=8 orthogonal sequences of the antenna ports are generated and sent.

For example, a basic port sequence of one port is (E1, E2, E3, E4, . . . , En), and after a frequency domain OCC with a code length of 2 (i.e., FD-OCC2) is applied: an SRS sequence of one port: (E1*w0(0), E2*w0(1), E3*w0(0), E4*w0(1), . . . ), namely [+1,+1] is applied; and an SRS sequence of another port: (E1*w1(0), E2*w1(1), E3*w1(0), E4*w1(1), . . . ), namely [+1,−1] is applied. Where FD refers to a frequency domain. SRSs of at least two sets of antenna ports are sent by the terminal on the same transmission comb.

For example, FD-OCC2 is as shown in Table 2, FD-OCC2 include 2 OCCs, each OCC with a code length of 2.

TABLE 2

| f2 | w_{f2}(k2) |
|---|---|
| 0 | [+1 +1] |
| 1 | [+1 −1] |

As shown in Table 2, f2 represents the serial number of the OCC, a value of f2 is 0 or 1, representing a total of 2 OCCs. K2 is a code length of the OCC, and a value of K2 is 2. Further, w_{f2}(k2) is the f2^{th} OCC with the code length of K2.

For example, as shown in FIG. 5, a transmission comb parameter of 1 transmission comb is 3; the transmission comb resource occupies continuous time slot symbols 10 to 13, that is to say, the transmission comb resource occupies 4 OFDM symbols. A frequency domain offset value parameter of the transmission comb is 0. Among the 8 antenna ports, the port 0 and the port 1 are a first set of antenna ports, the port 2 and the port 3 are a second set of antenna ports, the port 4 and the port 5 are a third set of antenna ports, and the port 6 and the port 7 are a fourth set of antenna ports. Each set of antenna ports corresponds to one basic port sequence, and the basic port sequence 1 of 1 antenna port in the first set of antenna ports is multiplied by a first OCC (i.e., OCC2) and a second OCC (i.e., OCC1) with code lengths of 2 respectively to obtain 2 orthogonal sequences (i.e., SRS sequences) corresponding to the port 0 and the port 1 in the first set of antenna ports. Taking the expansion of the basic port sequence 1 as an example, if the basic port sequence 1 is [Y1, Y2, Y3, Y4], it is multiplied by OCC2 to obtain the SRS sequence of the port 0: [Y1, Y2, Y3, Y4], it is multiplied by OCC1 to obtain the SRS sequence of the port 1: [(−1)Y1, Y2, (−1)Y3, Y4], and so on, the OCC is applied to the basic port sequences 1 to 4 respectively, and the SRS sequences of the 8 antenna ports are obtained by expansion.

In the Second Example, in a case of K=4, expansion is performed by the terminal by applying the OCC to the basic port sequences corresponding to the 2 antenna ports respectively, and 2×4=8 orthogonal sequences of the antenna ports are generated and sent.

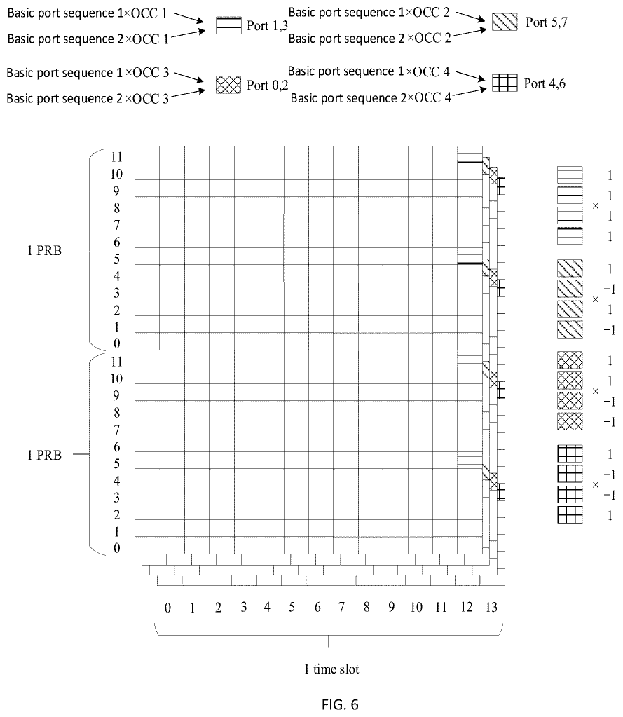

For example, as shown in FIG. 6, a transmission comb parameter of 1 transmission comb is 6; the transmission comb resource occupies a symbol 13, that is to say, the transmission comb resource occupies 1 OFDM symbols; and a frequency domain offset value parameter of the transmission comb is 5. The terminal multiplies 2 basic port sequences of 2 antenna ports by a first OCC with a code length of 4 (i.e., OCC1) to obtain 2 SRS sequences, multiplies these 2 basic port sequences by a second OCC with a code length of 4 (i.e., OCC2) to obtain 2 SRS sequences, multiplies these 2 basic port sequences by a third OCC with a code length of 4 (i.e., OCC3) to obtain 2 SRS sequences, and multiplies these 2 basic port sequences by a fourth OCC with a code length of 4 (i.e., OCC4) to obtain 2 SRS sequences. Taking the expansion of the basic port sequence 1 as an example, if the basic port sequence 1 is [Z1, Z2, Z3, Z4], it is multiplied by OCC1 to obtain the SRS sequence of the port 1: [Z1, Z2, Z3, Z4], it is multiplied by OCC2 to obtain the SRS sequence of the port 5: [Z1, (−1)Z2, Z3, (−1)Z4], it is multiplied by OCC3 to obtain the SRS sequence of the port 0: [Z1, Z2, (−1)Z3, (−1)Z4], it is multiplied by OCC4 to obtain the SRS sequence of the port 4: [Z1, (−1)Z2, (−1)Z3, Z4], and so on, the OCC is applied to the 2 basic port sequences respectively, and the SRS sequences of the 8 antenna ports are obtained by expansion.

For example, a frequency domain OCC with a code length of 4 (i.e., FD-OCC4) is as shown in Table 3. FD-OCC4 include 4 OCCs, each OCC with a code length of 4.

TABLE 3

| f3 | w_{f3}(k3) |
|---|---|
| 0 | [+1 +1 +1 +1] |
| 1 | [+1 −1 +1 −1] |
| 2 | [+1 +1 −1 −1] |
| 3 | [+1 −1 −1 +1] |

As shown in Table 3, f3 represents the serial number of the OCC, a value of f3 is ranges from 0 to 3, representing a total of 4 OCCs. K3 is a code length of the OCC, and a value of K3 is 4. Further, w_{f3}(k3) is the f₃th OCC with the code length of K3.

In the Third Example, in a case of K=8, expansion is performed by the terminal by applying the OCC to the basic port sequence corresponding to the 1 antenna port, and 1×8=8 orthogonal sequences of the antenna ports are generated and sent.

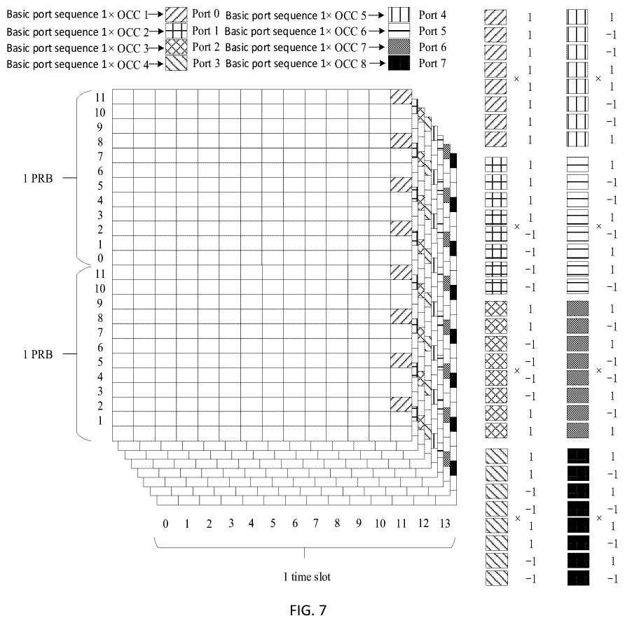

For example, as shown in FIG. 7, a transmission comb parameter of 1 transmission comb is 3; the transmission comb resource occupies a symbol 13, that is to say, the transmission comb resource occupies 1 OFDM symbols; and a frequency domain offset value parameter of the transmission comb is 2. The SRS sequences of the 8 antenna ports are obtained by the terminal based on multiplication of the basic port sequence of one antenna port by 8 OCCs with a code length of 8. For instance, if the basic port sequence 1 is [H1, H2, H3, H4, H5, H6, H7, H8], it is multiplied by OCC1 to obtain the SRS sequence of the port 0: [H1, H2, H3, H4, H5, H6, H7, H8]; it is multiplied by OCC2 to obtain the SRS sequence of the port 1: [H1, H2, H3, H4, (−1)H5, (−1)H6, (−1)H7, (−1)H8]; it is multiplied by OCC3 to obtain the SRS sequence of the port 2: [H1, H2, (−1)H3, (−1)H4, (−1)H5, (−1)H6, H7, H8]; it is multiplied by OCC4 to obtain the SRS sequence of the port 3: [H1, H2, (−1)H3, (−1)H4, H5, H6, (−1)H7, (−1)H8]; it is multiplied by OCC5 to obtain the SRS sequence of the port 4: [H1, (−1)H2, (−1)H3, H4, H5, (−1)H6, (−1)H7, H8]; it is multiplied by OCC6 to obtain the SRS sequence of the port 5: [H1, (−1)H2, (−1)H3, H4, (−1)H5, H6, H7, (−1)H8]; it is multiplied by OCC7 to obtain the SRS sequence of the port 6: [H1, (−1)H2, H3, (−1)H4, (−1)H5, H6, (−1)H7, H8]; it is multiplied by OCC8 to obtain the SRS sequence of the port 7: [H1, (−1)H2, H3, (−1)H4, H5, (−1)H6, H7, (−1)H8], and the SRS sequences of the 8 antenna ports are obtained by expansion.

Alternatively, the OCC is frequency domain OCC; or the OCC is time domain OCC. That is, the frequency domain OCC is adopted on the same transmission comb, as shown in FIG. 3; and the time domain OCC is adopted on the same transmission comb, as shown in FIG. 5.

Alternatively, after M×K=8 orthogonal sequences of the antenna ports are generated by the terminal, in a case of M=1, the 8 generated orthogonal sequences are mapped to the 8 antenna ports sequentially according to a sequence of applying the OCC to the basic port sequences; and in a case of M>1, the 8 generated orthogonal sequences are mapped to the 8 antenna ports sequentially according to a sequence of applying the OCC to the basic port sequences after the basic port sequences are ranked according to the cyclic shift parameters from small to large.

For instance, in a case of M=1, the 8 orthogonal sequences generated by applying OCC8 are mapped to the port 0 to the port 7 sequentially; and in a case of M=2, the 2 basic port sequences include: the basic port sequence 1 and the basic port sequence 2, based on the basic port sequence 1, 4 orthogonal sequences generated by applying OCC4 are mapped to the port 0, the port 1, the port 2 and the port 3 sequentially, and based on the basic port sequence 2, 4 orthogonal sequences generated by applying OCC4 are mapped to the port 4, the port 5, the port 6 and the port 7 sequentially.

Alternatively, part or all of the configuration information of the SRS resource is configured for the terminal by the network device, and/or, part or all of the configuration information of the SRS resource is defined by a protocol. The configuration information of the SRS resource includes at least one of the following: a transmission comb parameter K_{TC} of the transmission comb; a frequency domain offset value parameter k̅_{TC} of the transmission comb, where a value of k̅_{TC} is a non-negative integer less than K_{TC}; a time domain position of the transmission comb; the quantity of the antenna ports Nₐₚ^{SRS}=8; a cyclic shift parameter n_{SRS}^{cs}; or a sequence length K of the OCC.

In some examples, one transmission comb is configured for the terminal by the network device, thus, before step 420, the transmission comb parameter K_{TC} of the one transmission comb configured for the SRS resource is received by the terminal, and a value set of K_{TC} is {2,4,6,8,12}, that is, a value of K_{TC} is 2, or 4, or 6, or 8, or 12.

One frequency domain offset value parameter k_{TC} of the transmission comb is further received by the terminal, where a value of k_{TC} is a non-negative integer less than K_{TC}. For instance, when the value of K_{TC} is 4, the value of the configured k_{TC} may be 0, or 1, or 2, or 3.

The time domain position of the transmission comb is further received by the terminal. For instance, the configured time domain position is two continuous symbols 9 and 10 on a time slot.

In other examples (not shown in the flow charts), before step 420, one cyclic shift parameter configured for the SRS resource is further received by the terminal, and then M quantity of basic port sequences corresponding to M quantity of antenna ports are generated based on the one cyclic shift parameter. Alternatively, M quantity of cyclic shift parameters configured for the SRS resource are received by the terminal, and then M quantity of basic port sequences corresponding to the M quantity of antenna ports are generated based on the M quantity of cyclic shift parameters.

The 8 antenna ports may be divided into P sets, where P is 2 or 4. Alternatively, the P sets of antenna ports are obtained by sequential division of the 8 antenna ports according to port numbers; or, the P sets of antenna ports are obtained by odd-even division of the 8 antenna ports according to port numbers; or, the P sets of antenna ports are obtained by dividing the 8 antenna ports according to a combination manner predefined by a protocol; or, the P sets of antenna ports are obtained by sequential division of the 8 antenna ports with odd port numbers to obtain at least two first sets of antenna ports, and sequential division of the 8 antenna ports with even port numbers to obtain at least two second sets of antenna ports.

To sum up, the method for sending an SRS provided by the present example supports SRS sending of a plurality of sets of antenna ports on the same transmission comb, and each set of antenna ports supports expansion to 8 antenna ports.

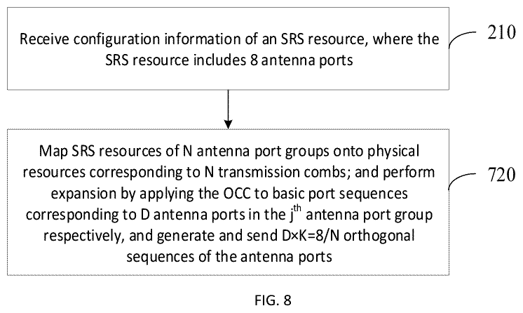

In some examples, the SRSs of the 8 antenna ports may be sent through different transmission combs, and as shown in FIG. 8, step 220 from FIG. 2 may be implemented as step 720.

In step 720, SRS resources of N antenna port groups are mapped onto physical resources corresponding to N transmission combs; and expansion is performed by applying the OCC to basic port sequences corresponding to D antenna ports in the j^{th} antenna port group respectively, and D×K=8/N orthogonal sequences of the antenna ports are generated and sent.

The 8 antenna ports are divided into N antenna port groups, each antenna port group includes 8/N antenna ports, and N is 2 or 4, where D is an even number not greater than 8/N, K is a sequence length of the OCC, a value of K is 2 or 4, and j is a positive integer not greater than N. For example, a basic port quantity in each group is D.

For example, a dividing manner of the N antenna port groups includes at least one of the following i-iv.
i) The N antenna port groups are obtained by sequential grouping of the 8 antenna ports according to port numbers. For example, one antenna port group includes a port 0, a port 1, a port 2 and a port 3, and another antenna port group includes a port 4, a port 5, a port 6 and a port 7.
ii) The N antenna port groups are obtained by odd-even grouping of the 8 antenna ports according to port numbers. For instance, one antenna port group includes the port 0, the port 2, the port 4 and the port 6, and another antenna port group includes the port 1, the port 3, the port 5 and the port 7.
iii) The N antenna port groups are obtained by sequential grouping of the 8 antenna ports with odd port numbers to obtain at least two first antenna port groups, and sequential grouping of the 8 antenna ports with even port numbers to obtain at least two second antenna port groups. For example, one first antenna port group includes the port 1 and the port 3, and another first antenna port group includes the port 5 and the port 7; and one second antenna port group includes the port 0 and the port 2, and another second antenna port group includes the port 4 and the port 6.
iv) The N antenna port groups are obtained by grouping the 8 antenna ports according to a combination manner predefined by a protocol. For instance, the protocol predefines that the port 0, the port 1, the port 6 and the port 7 are an antenna port group, and the port 2, the port 3, the port 4 and the port 5 are another antenna port group.

The antenna ports in each antenna port group may further be continuously divided into P sets, where P is 2 or 4. Alternatively, the P sets of antenna ports are obtained by sequential division of the 8/N antenna ports according to port numbers; or, the P sets of antenna ports are obtained by odd-even division of the 8/N antenna ports according to port numbers; or, the P sets of antenna ports are obtained by dividing the 8/N antenna ports according to a combination manner predefined by a protocol; or, the P sets of antenna ports are obtained by sequential division of the 8/N antenna ports with odd port numbers to obtain at least two first sets of antenna ports, and sequential division of the 8/N antenna ports with even port numbers to obtain at least two second sets of antenna ports.

Respective antenna ports in the j^{th} antenna port group in the N antenna port groups may be further expanded by adopting OCC, as follows.

First, the 8 antenna ports are divided into 2 antenna port groups, and in a case that each antenna port group includes 4 antenna ports, an expansion manner of the 8 antenna ports includes at least one of the following in a case of K=2, expansion is performed by applying the OCC to basic port sequences corresponding to 2 antenna ports in the j^{th} antenna port group respectively, and 2×2=4 orthogonal sequences of the antenna ports are generated and sent.

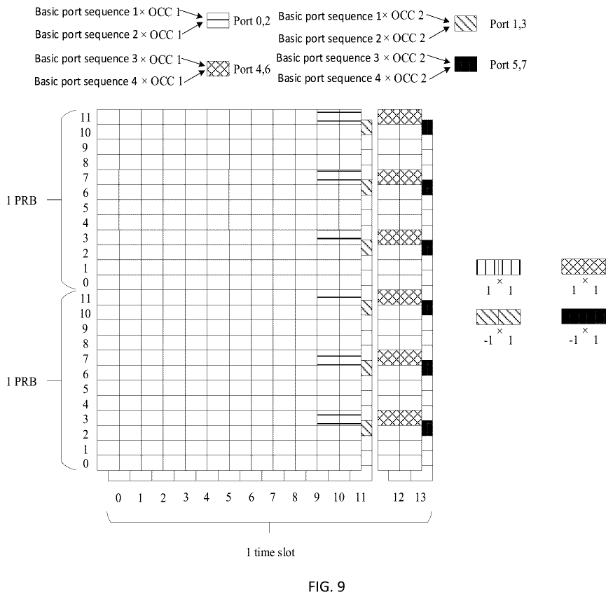

For example, as shown in FIG. 9, a transmission comb parameter of 2 transmission combs is 4; the transmission comb resource occupies continuous time slot symbols 10 to 13, for instance, the transmission comb resource occupies 4 continuous OFDM symbols; and frequency domain offset value parameters of the two transmission combs are both 3. A first antenna port group corresponding to one transmission comb includes a first set of antenna ports and a second set of antenna ports, the first set of antenna ports includes a port 0 and a port 1, and the second set of antenna ports includes a port 2 and a port 3; and a second antenna port group corresponding to the other transmission comb includes a third set of antenna ports and a fourth set of antenna ports, the third set of antenna ports includes a port 4 and a port 5, and the fourth set of antenna ports includes a port 6 and a port 7. For the first antenna port group, the terminal multiplies the two basic port sequences of the first set of antenna ports by a first OCC (i.e., OCC1) and a second OCC (i.e., OCC2) with code lengths of 2 to obtain orthogonal sequences of 4 antenna ports in the first antenna port group; for instance, the basic port sequence 1 corresponding to the port 0 is [L1, L2], it is multiplied by OCC1 to obtain an SRS sequence of the port 0: [L1, L2], and it is multiplied by OCC2 to obtain an SRS sequence of the port 1: [(−1)L1, L2]; the basic port sequence 2 corresponding to the port 2 is [L3, L4], it is multiplied by OCC1 to obtain an SRS sequence of the port 2: [L3, L4], and it is multiplied by OCC2 to obtain an SRS sequence of the port 3: [(−1)L3, L4]; and so on, the second antenna port group is expanded to obtain orthogonal sequences of 4 antenna ports.

In a case of K=4, expansion is performed by applying the OCC to a basic port sequence corresponding to 1 antenna port in the j^{th} antenna port group, and 1×4=4 orthogonal sequences of the antenna ports are generated and sent.

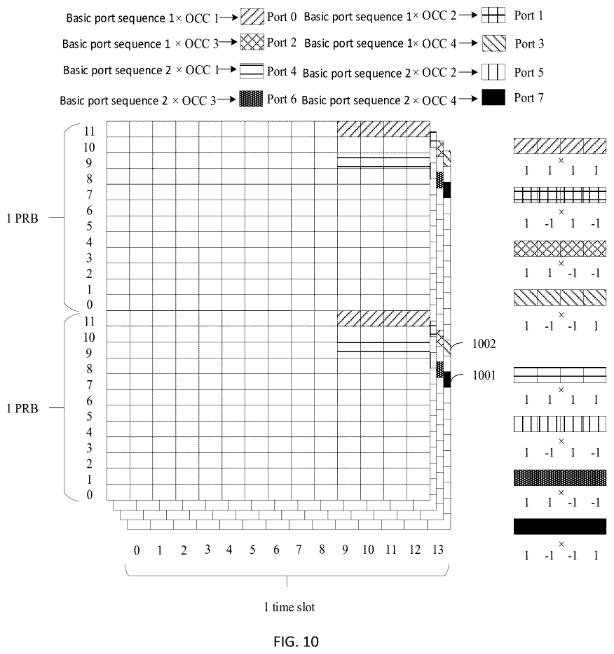

For example, as shown in FIG. 10, a transmission comb parameter of 2 transmission combs is 12; the transmission comb resource occupies continuous time slot symbols 10 to 13, for instance, the transmission comb resource occupies 4 continuous OFDM symbols; and a frequency domain offset value parameter of the transmission comb 1001 is 9, and a frequency domain offset value parameter of the transmission comb 1002 is 11. A first antenna port group corresponding to the transmission comb 1002 includes 4 antenna ports: a port 0, a port 1, a port 2 and a port 3; and a second antenna port group corresponding to the transmission comb 1001 includes 4 antenna ports: a port 4, a port 5, a port 6 and a port 7. For the first antenna port group, the terminal multiplies a basic port sequence of 1 antenna port in the first antenna port group by 4 OCCs with a code length of 4, and performs expansion to obtain orthogonal sequences of the 4 antenna ports. For instance, if the basic port sequence 1 of the port 0 is [B1, B2, B3, B4], it is multiplied by OCC1 to obtain an SRS sequence of the port 0: [B1, B2, B3, B4], it is multiplied by OCC2 to obtain an SRS sequence of the port 1: [B1, (−1)B2, B3, (−1)B4], it is multiplied by OCC3 to obtain an SRS sequence of the port 2: [B1, B2, (−1)B3, (−1)B4], and it is multiplied by OCC4 to obtain an SRS sequence of the port 3: [B1, (−1)B2, (−1)B3, B4]. And so on, the terminal multiplies a basic port sequence of 1 antenna port in the second antenna port group by 4 OCCs with a code length of 4, and performs expansion to obtain orthogonal sequences of the 4 antenna ports.

Second, the 8 antenna ports are divided into 4 antenna port groups, and in a case that each antenna port group includes 2 antenna ports, an expansion manner of the 8 antenna ports includes at least one of the following in a case of K=2, expansion is performed by applying the OCC to a basic port sequence corresponding to 1 antenna port in the j^{th} antenna port group, and 1×2=2 orthogonal sequences of the antenna ports are generated and sent.

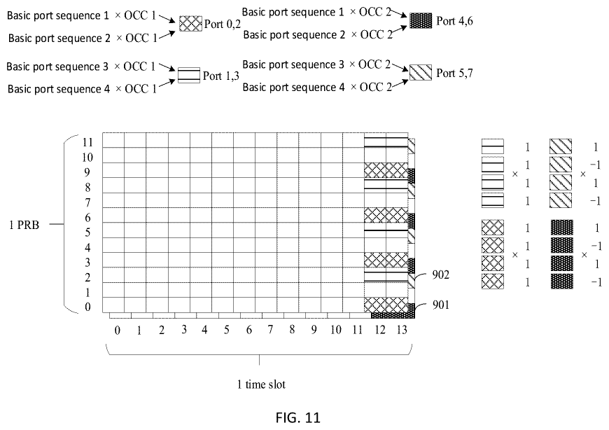

For example, as shown in FIG. 11, a transmission comb parameter of 2 transmission combs is 3; the transmission comb resource occupies continuous time slot symbols 12 and 13, for instance, the transmission comb resource occupies 2 continuous OFDM symbols; and a frequency domain offset value parameter of one transmission comb is 0, and a frequency domain offset value parameter of the other transmission comb is 2. The transmission comb 901 corresponds to a first antenna port group and a second antenna port group, the first antenna port group includes a port 0 and a port 4, and the second antenna port group includes a port 2 and a port 6; and the transmission comb 902 corresponds to a third antenna port group and a fourth antenna port group, the third antenna port group includes a port 1 and a port 5, and the fourth antenna port group includes a port 3 and a port 7. For the first antenna port group, the terminal multiplies a basic port sequence of 1 antenna port in the first antenna port group by a first OCC (i.e., OCC1) and a second OCC (i.e., OCC2) with code lengths of 2 to obtain orthogonal sequences of 2 antenna ports in the first antenna port group; for instance, if the basic port sequence corresponding to the port 0 is [R1, R2, R3, R4], it is multiplied by OCC1 to obtain an SRS sequence of the port 0: [R1, R2, R3, R4], and it is multiplied by OCC2 to obtain an SRS sequence of the port 4: [R1, (−1)R2, R3, (−1)R4]; and so on, the remaining three antenna port groups are expanded to obtain orthogonal sequences of 6 antenna ports.

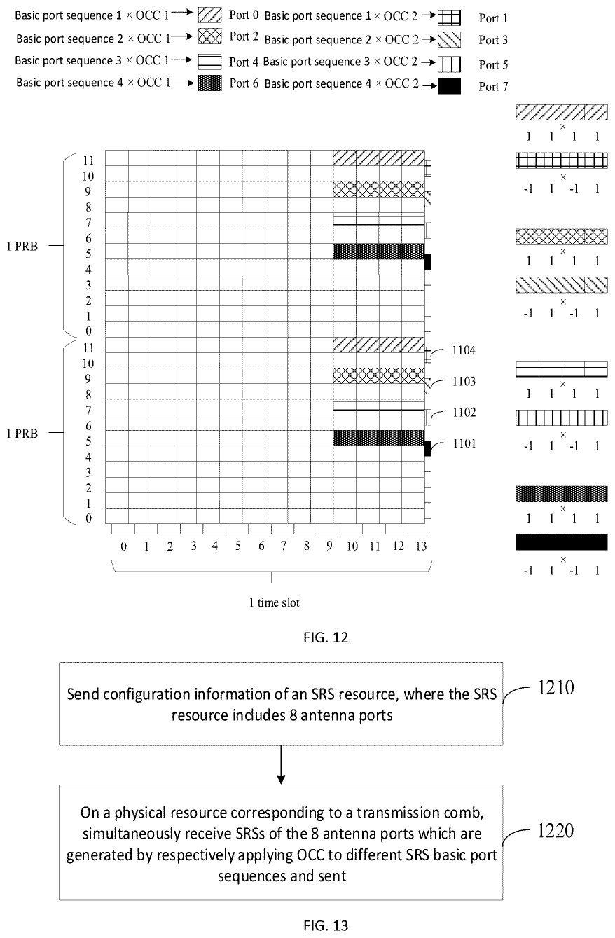

For example, as shown in FIG. 12, a transmission comb parameter of 4 transmission combs is 12; the transmission comb resource occupies continuous time slot symbols 10 to 13, for instance, the transmission comb resource occupies 4 continuous OFDM symbols; and frequency domain offset value parameters of the 4 transmission combs are 5, 7, 9, and 11. One antenna port group corresponding to the transmission comb 1101 includes a port 6 and a port 7; another antenna port group corresponding to the transmission comb 1102 includes a port 4 and a port 5; another antenna port group corresponding to the transmission comb 1103 includes a port 3 and a port 4, and another antenna port group corresponding to the transmission comb 1104 includes a port 0 and a port 1. The terminal multiplies a basic port sequence of 1 port in one antenna port group by two OCCs with a code length of 2 to obtain orthogonal sequences of two antenna ports. For one antenna port group, the basic port sequence of the port 0 is [T1, T2, T3, T4], it is multiplied by OCC1 to obtain an SRS sequence of the port 0: [T1, T2, T3, T4], and it is multiplied by OCC2 to obtain an SRS sequence of the port 1: [T1, (−1)T2, T3, (−1)T4]; and so on, the remaining three antenna port groups are expanded to obtain orthogonal sequences of 6 antenna ports.

Alternatively, part or all of the configuration information of the SRS resource is configured for the terminal by the network device, and/or, part or all of the configuration information of the SRS resource is defined by a protocol. The configuration information of the SRS resource includes at least one of the following a transmission comb parameter K_{TC} of the transmission comb; a frequency domain offset value parameter k̅_{TC} of the transmission comb, where a value of k̅_{TC} is a non-negative integer less than K_{TC}; a time domain position of the transmission comb; the quantity of the antenna ports Nₐₚ^{SRS}=8; a cyclic shift parameter n_{SRS}^{cs}; a sequence length K of the OCC; and/or the quantity of the antenna port groups N, or, the quantity of the transmission combs N.

Alternatively, the transmission comb parameters K_{TC} of the transmission combs corresponding to the N antenna port groups are the same.

Alternatively, frequency domain offset value parameters k̅_{TC} of the N transmission combs are different, and a value of k_{TC} is a non-negative integer less than N. For instance, the frequency domain offset value parameters of the 4 transmission combs in FIG. 12 are 5, 7, 9, and 11 respectively.

In some examples, before step 720 is executed in FIG. 8, one cyclic shift parameter configured for the SRS resource is further received by the terminal, and D basic port sequences corresponding to all the D antenna ports in each antenna port group are generated based on the cyclic shift parameter (not shown).

Alternatively, before step 720 is executed in FIG. 8, N cyclic shift parameters configured for the SRS resource are further received by the terminal, and D basic port sequences corresponding to all the D antenna ports in each antenna port group are generated based on the N cyclic shift parameters (not shown).

For instance, as shown in FIG. 12, one cyclic shift parameter of 4 antenna port groups configured for the SRS resource is received by the terminal, a basic port sequence of 1 antenna port in each antenna port group is generated based on the cyclic shift parameter to obtain 4 basic port sequences corresponding to the 4 antenna port groups, then each basic port sequence is multiplied by two OCCs with a code length of 2 to obtain 2 orthogonal sequences of 2 antenna ports by expansion, and finally 8 orthogonal sequences corresponding to the 4 antenna port groups are obtained. Alternatively, 4 cyclic shift parameters of 4 antenna port groups configured for the SRS resource are received by the terminal, a basic port sequence of 1 antenna port in each antenna port group is generated based on each cyclic shift parameter to obtain 4 basic port sequences corresponding to the 4 antenna port groups, then each basic port sequence is multiplied by two OCCs with a code length of 2 to obtain 2 orthogonal sequences of 2 antenna ports by expansion, and finally 8 orthogonal sequences corresponding to the 4 antenna port groups are obtained.

Alternatively, after D×K=8/N orthogonal sequences of the antenna ports are generated by the terminal, in a case that the j^{th} antenna port group corresponds to one basic port sequence, the 8/N generated orthogonal sequences are mapped to the 8/N antenna ports in the j^{th} antenna port group sequentially according to a sequence of applying the OCC to the basic port sequences; and in a case that the j^{th} antenna port group corresponds to D basic port sequences, the 8/N generated orthogonal sequences are mapped to the 8/N antenna ports in the j^{th} antenna port group sequentially according to a sequence of applying the OCC to the basic port sequences after the basic port sequences are ranked according to the cyclic shift parameters from small to large. For instance, the 8 antenna ports are divided into two groups: the port 0, the port 2, the port 4 and the port 6 are one group, and the port 1, the port 3, the port 5 and the port 7 are one group; for a case that one antenna port group corresponds to one basic port sequence, the 4 orthogonal sequences generated by applying OCC4 are mapped to the port 0, the port 2, the port 4 and the port 6 sequentially, or the 4 orthogonal sequences generated by applying OCC4 are mapped to the port 1, the port 3, the port 5 and the port 7 sequentially; and for a case that one antenna port group corresponds to the basic port sequence 1 and the basic port sequence 2, based on the basic port sequence 1, the 4 orthogonal sequences generated by applying OCC4 are mapped to the port 0, the port 2, the port 4 and the port 6 sequentially, and based on the basic port sequence 2, the 4 orthogonal sequences generated by applying OCC4 are mapped to the port 1, the port 3, the port 5 and the port 7 sequentially.

In other examples, before step 720 is executed in FIG. 8, a first frequency domain offset value parameter of a transmission comb corresponding to a first antenna port group configured for the SRS resource is further received by the terminal, and the first antenna port group is one of the N antenna port groups; and other frequency domain offset value parameters of transmission combs corresponding to other antenna port groups are calculated by the terminal based on the first frequency domain offset value parameter, and the other antenna port groups are one of the N antenna port groups other than the first antenna port group (not shown).

Alternatively, before step 720 is executed in FIG. 8, frequency domain offset value parameters of transmission combs corresponding to the N antenna port groups configured for the SRS resource are further received by the terminal (not shown).

That is, a frequency domain offset value parameter k_{TC} of one transmission comb is configured for the terminal by the network device, and then other frequency domain offset value parameters k_{TC}^{(pi)} of other transmission combs are calculated based on this frequency domain offset value parameter; or, one group of frequency domain offset value parameters corresponding to at least two transmission combs is configured for the terminal by the network device.

For example, a determining principle for other frequency domain offset value parameters includes any one of the following 1-4.

### 1) An Adjacent Transmission Comb Principle.

A frequency domain offset value parameter k_{Tp}c) of each port corresponding to other transmission combs is generated according to the following formula (1) or (2)

$${k}_{TC}^{( {p}_{i} )} = {\overline{k}}_{TC} + 1 \qquad Formula ( 1 )$$

$${k}_{TC}^{( {p}_{i} )} = {\overline{k}}_{TC} - 1 \qquad Formula ( 2 )$$

That is, two-by-two corresponding sub-carriers between two adjacent transmission combs are adjacent.

### 2) A Uniform Distribution Principle.

A frequency domain offset value parameter k_{TC}^{(pi)} of each port corresponding to other transmission combs is generated according to the following formula (3)

$${k}_{TC}^{( {p}_{i} )} = ( {\overline{k}}_{TC} + {K}_{TC} / 2 ) mod {K}_{TC} \qquad Formula ( 3 )$$

For example, K_{TC} of a third transmission comb and a fourth transmission comb in the SRS resource is equal to 4, where a frequency domain offset value parameter of the third transmission comb is 3, and a frequency domain offset value parameter of the fourth transmission comb is 1; the third transmission comb and the fourth transmission comb each occupy time slot symbols 12 and 13; adjacent sub-carriers in each transmission comb are spaced by 3 sub-carriers, sub-carriers occupied by the third transmission comb include a sub-carrier 1, a sub-carrier 5, and a sub-carrier 9, and sub-carriers occupied by the fourth transmission comb include a sub-carrier 3, a sub-carrier 7, and a sub-carrier 11; and in 6 sub-carriers corresponding to the two transmission combs, every two adjacent sub-carriers are spaced by 1 sub-carrier, that is, the two transmission combs accord with the uniform distribution principle.

### 3) A Maximum Spacing Principle.

A difference of frequency domain offset value parameters between connected transmission combs is the maximum. For instance, in a case of K_{TC}=4, a first frequency domain offset value parameter is 0, then other frequency domain offset value parameters are 3, and thus at least two transmission combs accord with the maximum spacing principle.

For example, K_{TC} of a fifth transmission comb and a sixth transmission comb in the SRS resource is equal to 8, where a frequency domain offset value parameter of the fifth transmission comb is 0, and a frequency domain offset value parameter of the sixth transmission comb is 7; the fifth transmission comb and the sixth transmission comb each occupy 4 continuous time slot symbols 8 to 11; adjacent sub-carriers in each transmission comb are spaced by 7 sub-carriers, sub-carriers occupied by the fifth transmission comb include a sub-carrier 0 and a sub-carrier 8 of the first PRB, as well as a sub-carrier 4 of the second PRB, and sub-carriers occupied by the sixth transmission comb include a sub-carrier 7 of the first PRB, as well as a sub-carrier 3 and a sub-carrier 11 of the second PRB; and in 6 sub-carriers corresponding to the two transmission combs, every two corresponding sub-carriers are spaced by 6 sub-carriers, that is, the two transmission combs accord with the maximum spacing principle.

### 4) Other Predefined Principles.

The other predefined principles may be other manners defined by a protocol to determine other frequency domain offset value parameters.

Alternatively, the physical resources corresponding to the N transmission combs are different in frequency domain position and the same in time domain position; and as shown in FIG. 12, the 4 transmission combs are located on the sub-carriers 5, 7, 9, and 11 of two PRBs respectively.

Alternatively, the physical resources corresponding to the N transmission combs are different in time domain position and the same in frequency domain position; as shown in FIG. 9, 2 transmission combs are both located on the sub-carriers 3, 7, and 11 of the first PRB as well as the sub-carriers 3, 7, and 11 of the second PRB; and the transmission comb 801 is located on time slot symbols 10 and 11, and the transmission comb 802 is located on time slot symbols 12 and 13.

For example, as shown in FIG. 9, transmission comb parameters of 2 transmission combs are 4; the transmission comb resources occupy continuous time slot symbols 10 to 13, that is to say, the 2 transmission comb resources occupy 4 OFDM symbols; and frequency domain offset value parameters of the transmission combs are 3. The 8 antenna ports are divided into two groups: a first antenna port group and a second antenna port group, the first antenna port group includes: a port 0, a port 1, a port 2 and a port 3, and the second antenna port group includes: a port 4, a port 5, a port 6 and a port 7; the first antenna port group includes a first set of antenna ports and a second set of antenna ports, the first set of antenna ports includes the port 0 and the port 1, and the second set of antenna ports includes the port 2 and the port 3; and the second antenna port group includes a third set of antenna ports and a fourth set of antenna ports, the third set of antenna ports includes the port 4 and the port 5, and the fourth set of antenna ports includes the port 6 and the port 7.

Alternatively, the OCC is frequency domain OCC; or the OCC is time domain OCC. That is, the frequency domain OCC is adopted on different transmission combs, as shown in FIG. 11; and the time domain OCC is adopted on different transmission combs, as shown in FIG. 9.

Alternatively, each antenna port group includes K antenna ports, and K is 2 or 4; at least two sets of antenna ports are obtained by sequential division of K antenna ports according to port numbers; or, the at least two sets of antenna ports are obtained by odd-even division of the K antenna ports according to port numbers; or, the at least two sets of antenna ports are obtained by dividing the K antenna ports according to a combination manner predefined by a protocol; or, the at least two sets of antenna ports are obtained by sequential division of the K antenna ports with odd port numbers to obtain at least two first sets of antenna ports, and sequential division of the K antenna ports with even port numbers to obtain at least two second sets of antenna ports.

It should be noted that, the division manners for the at least two sets of antenna ports and the at least two antenna port groups may be the same or different.

To sum up, the method for sending an SRS provided by the present example supports SRS sending of a plurality of antenna port groups on a plurality of transmission combs on different frequency domain dimensions or time domain dimensions.

FIG. 13 shows a method flow diagram of a method for receiving an SRS provided by an example of the disclosure. The method is applied to the network device of the communication system shown in FIG. 1, and the method includes steps 1210 and 1220.

In step 1210, configuration information of an SRS resource is sent, where the SRS resource includes 8 antenna ports.

Alternatively, the configuration information includes at least one of the following: a transmission comb parameter K_{TC}; a frequency domain offset value parameter k̅_{TC}; a bandwidth parameter; a cyclic shift parameter n_{SRS}^{cs}; the quantity of the antenna ports Nₐₚ^{SRS}; a time domain position of a transmission comb; a sequence length K of OCC; and/or the quantity of antenna port groups N, or, the quantity of transmission combs N.

For example, a first frequency domain offset value parameter of a transmission comb corresponding to a first antenna port group is sent by the network device to a terminal, where the first antenna port group is one of N antenna port groups; or, frequency domain offset value parameters of transmission combs corresponding to the N antenna port groups are sent by the network device.

For example, the N antenna port groups are sent to the terminal by the network device. The N antenna port groups are obtained by sequential grouping of the 8 antenna ports according to port numbers; or, the N antenna port groups are obtained by odd-even grouping of the 8 antenna ports according to port numbers; or, the N antenna port groups are obtained by grouping according to a combination manner predefined by a protocol; or, the N antenna port groups are obtained by sequential grouping of the 8 antenna ports with odd port numbers to obtain at least two first antenna port groups, and sequential grouping of the 8 antenna ports with even port numbers to obtain at least two second antenna port groups.

The N antenna port groups correspond to N transmission combs; physical resources corresponding to the N configured transmission combs are different in frequency domain position and the same in time domain position; or, the physical resources corresponding to the N configured transmission combs are different in time domain position and the same in frequency domain position. Alternatively, the OCC is frequency domain OCC; or the OCC is time domain OCC.

For example, the quantity of the 8 configured antenna ports Nₐₚ^{SRS} is equal to 8; and port numbers of the 8 antenna ports Pᵢ are equal to 1000+i, i {0, 1, 2, 3, 4, 5, 6, 7}.

Alternatively, in a case that the physical resource is the physical resource corresponding to the same transmission comb, one cyclic shift parameter configured for the SRS resource, or M cyclic shift parameters configured for the SRS resource are sent by the network device, where M is a positive integer not greater than 8.

Alternatively, in a case that the physical resources are the physical resources corresponding to the N transmission combs, a first frequency domain offset value parameter of a transmission comb corresponding to a first antenna port group configured for the SRS resource is sent by the network device, where the first antenna port group is one of the N antenna port groups; or, frequency domain offset value parameters of transmission combs corresponding to the N antenna port groups configured for the SRS resource are sent by the network device.

Alternatively, in a case that the physical resources are the physical resources corresponding to the N transmission combs, one cyclic shift parameter configured for the SRS resource, or N cyclic shift parameters configured for the SRS resource are sent by the network device.

For example, a function of the SRS resource is at least one of the following: a codebook; antenna switching; or a non-codebook.

In step 1220: on a physical resource corresponding to a transmission comb, SRSs of the 8 antenna ports which are generated by respectively applying OCC to different SRS basic port sequences and sent are received simultaneously.

Alternatively, in a case that the physical resource is the physical resource corresponding to the same transmission comb, the SRSs of the 8 antenna ports include: M×K=8 orthogonal sequences of the antenna ports generated by performing expansion by respectively applying the OCC to basic port sequences corresponding to M antenna ports, where M is a positive integer not greater than 8, K is a sequence length of the OCC, and a value of K is 2, or 4 or 8.

For example, in a case of K=2, the SRSs of the 8 antenna ports include: 4×2=8 orthogonal sequences of the antenna ports generated by performing expansion by respectively applying the OCC to basic port sequences corresponding to 4 antenna ports; in a case of K=4, the SRSs of the 8 antenna ports include: 2×4=8 orthogonal sequences of the antenna ports generated by performing expansion by respectively applying the OCC to basic port sequences corresponding to 2 antenna ports; and in a case of K=8, the SRSs of the 8 antenna ports include: 1×8=8 orthogonal sequences of the antenna ports generated by performing expansion by respectively applying the OCC to a basic port sequence corresponding to 1 antenna port.

For example, in a case that 8 antenna ports are sent on the same transmission comb, the 8 antenna ports may be divided into Q sets of antenna ports, where Q is 2 or 4; the Q sets of antenna ports are obtained by sequential division of the 8 antenna ports according to port numbers; or, the Q sets of antenna ports are obtained by odd-even division of the 8 antenna ports according to port numbers; or, the Q sets of antenna ports are obtained by dividing the 8 antenna ports according to a combination manner predefined by a protocol; or, the Q sets of antenna ports are obtained by sequential division of the 8 antenna ports with odd port numbers to obtain at least two first sets of antenna ports, and sequential division of the 8 antenna ports with even port numbers to obtain at least two second sets of antenna ports.

Alternatively, the 8 antenna ports are divided into N antenna port groups, and each antenna port group includes 8/N antenna ports, where N is 2 or 4; in a case that the physical resource is the physical resources corresponding to the N transmission combs, SRSs of the 8/N antenna ports corresponding to the j^{th} antenna port group include: D×K=8/N orthogonal sequences of the antenna ports generated by performing expansion by respectively applying the OCC to basic port sequences corresponding to D antenna ports in the j^{th} antenna port group, where D is an even number not greater than 8/N, K is a sequence length of the OCC, a value of K is 2 or 4, and j is a positive integer not greater than N.

For example, the 8 antenna ports are divided into 2 antenna port groups, and each antenna port group includes 4 antenna ports; in a case of K=2, the SRSs of the 8/N antenna ports include: 2×2=4 orthogonal sequences of the antenna ports generated by performing expansion by respectively applying the OCC to basic port sequences corresponding to 2 antenna ports in the j^{th} antenna port group; and in a case of K=4, the SRSs of the 8/N antenna ports include: 1×4=4 orthogonal sequences of the antenna ports generated by performing expansion by respectively applying the OCC to a basic port sequence corresponding to 1 antenna port in the j^{th} antenna port group.

For example, the 8 antenna ports are divided into 4 antenna port groups, and each antenna port group includes 2 antenna ports; and in a case of K=2, the SRSs of the 8/N antenna ports include: 1×2=2 orthogonal sequences of the antenna ports generated by performing expansion by applying the OCC to a basic port sequence corresponding to 1 antenna port in the j^{th} antenna port group.

Alternatively, the transmission comb parameters K_{TC} of the transmission combs corresponding to the N antenna port groups are the same.

Alternatively, frequency domain offset value parameters k̅_{TC} of the N transmission combs are different, and a value of k̅_{TC} is a non-negative integer less than n.

Alternatively, the N antenna port groups are obtained by sequential grouping of the 8 antenna ports according to port numbers; or, the N antenna port groups are obtained by odd-even grouping of the 8 antenna ports according to port numbers; or, the N antenna port groups are obtained by grouping the 8 antenna ports according to a combination manner predefined by a protocol; or, the N antenna port groups are obtained by sequential grouping of the 8 antenna ports with odd port numbers to obtain at least two first antenna port groups, and sequential grouping of the 8 antenna ports with even port numbers to obtain at least two second antenna port groups.

For example, in a case that SRSs of at least two antenna port groups are sent on the N transmission combs, each antenna port group includes Q antenna ports, where Q is 2 or 4; at least two sets of antenna ports are obtained by sequential division of Q antenna ports according to port numbers; or, the at least two sets of antenna ports are obtained by odd-even division of the Q antenna ports according to port numbers; or, the at least two sets of antenna ports are obtained by dividing the Q antenna ports according to a combination manner predefined by a protocol; or, the at least two sets of antenna ports are obtained by sequential division of the Q antenna ports with odd port numbers to obtain at least two first sets of antenna ports, and sequential division of the Q antenna ports with even port numbers to obtain at least two second sets of antenna ports.

To sum up, in the method for receiving an SRS provided by the present example, on the physical resource corresponding to the transmission comb, the SRSs of the 8 antenna ports generated by respectively applying the OCC to the different SRS basic port sequences and sent are received. The method is used to support the realization of relevant functions in the case that 8 sending antenna ports are used by the terminal, for example, the method is used to support codebook-based channel quality detection in the case that the 8 sending antenna ports are used by the terminal, or to support non-codebook-based channel quality detection in the case that the 8 sending antenna ports are used by the terminal, or to support channel quality detection during antenna switching in the case that the 8 sending antenna ports are used by the terminal.

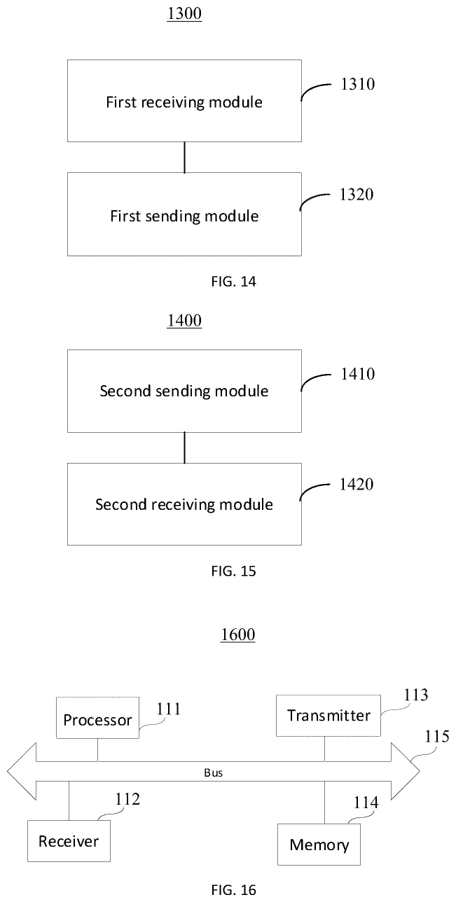

FIG. 14 shows a block diagram of an apparatus 1300 for sending an SRS provided by an example of the disclosure. The apparatus may be implemented as part or all of UE by means of software, hardware or a combination of the two. The apparatus 1300 includes a first receiving module 1310 and a first sending module 1320.

The first receiving module 1310 is configured to receive configuration information of an SRS resource, where the SRS resource includes 8 antenna ports.

The first sending module 1320 is configured to map the SRS resource onto a physical resource corresponding to a configured transmission comb, and generate and send SRSs of the 8 antenna ports by respectively applying orthogonal cover codes (OCC) to different SRS basic port sequences.

In some examples, the first sending module 1320 is configured to map the SRS resource onto a physical resource corresponding to the same transmission comb; and perform expansion by applying the OCC to basic port sequences corresponding to M antenna ports respectively, and generate and send M×K=8 orthogonal sequences of the antenna ports. Where M is a positive integer not greater than 8, K is a sequence length of the OCC, and a value of K is 2, or 4 or 8.

In some examples, the first sending module 1320 is configured to perform, in a case of K=2, expansion by applying the OCC to basic port sequences corresponding to 4 antenna ports respectively, and generate and send 4×2=8 orthogonal sequences of the antenna ports; and perform, in a case of K=4, expansion by applying the OCC to basic port sequences corresponding to 2 antenna ports respectively, and generate and send 2×4=8 orthogonal sequences of the antenna ports; and perform, in a case of K=8, expansion by applying the OCC to a basic port sequence corresponding to 1 antenna port, and generate and send 1×8=8 orthogonal sequences of the antenna ports.

In some examples, the configuration information of the SRS resource includes at least one of the following: a transmission comb parameter K_{TC} of the transmission comb; a frequency domain offset value parameter k̅_{TC} of the transmission comb, where a value of k̅_{TC} is a non-negative integer less than K_{TC}; a time domain position of the transmission comb; the quantity of the antenna ports Nₐₚ^{SRS}=8; a cyclic shift parameter n_{SRS}^{cs}; or a sequence length K of the OCC.

In some examples, the first receiving module 1310 is configured to receive one cyclic shift parameter configured for the SRS resource; and generate M basic port sequences corresponding to the M antenna ports based on the cyclic shift parameter.

In some examples, the first receiving module 1310 is configured to receive M cyclic shift parameters configured for the SRS resource; and generate M basic port sequences corresponding to the M antenna ports based on the M cyclic shift parameters.

In some examples, the 8 antenna ports are divided into N antenna port groups, and each antenna port group includes 8/N antenna ports, where N is 2 or 4; and the first sending module 1320 is configured to map SRS resources of the N antenna port groups onto physical resources corresponding to N transmission combs; and perform expansion by applying the OCC to basic port sequences corresponding to D antenna ports in the j^{th} antenna port group respectively, and generate and send D×K=8/N orthogonal sequences of the antenna ports. Where D is an even number not greater than 8/N, K is a sequence length of the OCC, a value of K is 2 or 4, and j is a positive integer not greater than N.

In some examples, the 8 antenna ports are divided into 2 antenna port groups, and each antenna port group includes 4 antenna ports; and the first sending module 1320 is configured to perform, in a case of K=2, expansion by applying the OCC to basic port sequences corresponding to 2 antenna ports in the j^{th} antenna port group respectively, and generate and send 2×2=4 orthogonal sequences of the antenna ports; and perform, in a case of K=4, expansion by applying the OCC to a basic port sequence corresponding to 1 antenna port in the j^{th} antenna port group, and generate and send 1×4=4 orthogonal sequences of the antenna ports.

In some examples, the 8 antenna ports are divided into 4 antenna port groups, and each antenna port group includes 2 antenna ports; and the first sending module 1320 is configured to perform, in a case of K=2, expansion by applying the OCC to a basic port sequence corresponding to 1 antenna port in the j^{th} antenna port group, and generate and send 1×2=2 orthogonal sequences of the antenna ports.

In some examples, the configuration information of the SRS resource includes at least one of the following: a transmission comb parameter K_{TC} of the transmission comb; a frequency domain offset value parameter k̅_{TC} of the transmission comb, where a value of k̅_{TC} is a non-negative integer less than K_{TC}; a time domain position of the transmission comb; the quantity of the antenna ports Nₐₚ^{SRS}=8; a cyclic shift parameter n_{SRS}^{cs}; a sequence length K of the OCC; and/or the quantity of the antenna port groups N, or, the quantity of the transmission combs N.

In some examples, the first receiving module 1310 is configured to receive a first frequency domain offset value parameter of a transmission comb corresponding to a first antenna port group configured for the SRS resource, the first antenna port group being one of the N antenna port groups; and calculate other frequency domain offset value parameters of transmission combs corresponding to other antenna port groups based on the first frequency domain offset value parameter, the other antenna port groups being one of the N antenna port groups other than the first antenna port group.

In some examples, the first receiving module 1310 is configured to receive frequency domain offset value parameters of transmission combs corresponding to the N antenna port groups configured for the SRS resource.

In some examples, the first receiving module 1310 is configured to receive one cyclic shift parameter configured for the SRS resource; and generate D basic port sequences corresponding to all the D antenna ports in each antenna port group based on the cyclic shift parameter.

In some examples, the first receiving module 1310 is configured to receive N cyclic shift parameters configured for the SRS resource; and generate D basic port sequences corresponding to all the D antenna ports in each antenna port group based on the N cyclic shift parameters.

In some examples, the transmission comb parameters K_{TC} of the transmission combs corresponding to the N antenna port groups are the same.

In some examples, the physical resources corresponding to the N transmission combs are different in frequency domain position and the same in time domain position; or, the physical resources corresponding to the N transmission combs are different in time domain position and the same in frequency domain position.

In some examples, the N antenna port groups are obtained by sequential grouping of the 8 antenna ports according to port numbers; or the N antenna port groups are obtained by odd-even grouping of the 8 antenna ports according to port numbers; or the N antenna port groups are obtained by grouping the 8 antenna ports according to a combination manner predefined by a protocol; or the N antenna port groups are obtained by sequential grouping of the 8 antenna ports with odd port numbers to obtain at least two first antenna port groups, and sequential grouping of the 8 antenna ports with even port numbers to obtain at least two second antenna port groups.

In some examples, the first sending module 1320 is configured to: map, after the M×K=8 orthogonal sequences of the antenna ports are generated, the 8 generated orthogonal sequences to the 8 antenna ports sequentially according to a sequence of applying the OCC to the basic port sequences in a case of M=1; and map, after the M×K=8 orthogonal sequences of the antenna ports are generated, the 8 generated orthogonal sequences to the 8 antenna ports sequentially according to a sequence of applying the OCC to the basic port sequences after the basic port sequences are ranked according to the cyclic shift parameters from small to large in a case of M>1.

In some examples, the first sending module 1320 is configured to: map, after the D×K=8/N orthogonal sequences of the antenna ports are generated, the 8/N generated orthogonal sequences to the 8/N antenna ports in the j^{th} antenna port group sequentially according to a sequence of applying the OCC to the basic port sequence in a case that the j^{th} antenna port group corresponds to one basic port sequence; and map, after the D×K=8/N orthogonal sequences of the antenna ports are generated, the 8/N generated orthogonal sequences to the 8/N antenna ports in the j^{th} antenna port group sequentially according to a sequence of applying the OCC to the basic port sequences after the basic port sequences are ranked according to the cyclic shift parameters from small to large in a case that the j^{th} antenna port group corresponds to D basic port sequences.

In some examples, the OCC is frequency domain OCC; or the OCC is time domain OCC.

In some examples, a function of the SRS resource is one of the following: a codebook; antenna switching; or a non-codebook.

FIG. 15 shows a block diagram of an apparatus 1400 for receiving an SRS provided by an example of the disclosure. The apparatus 1400 may be implemented as part or all of a network device by means of software, hardware or a combination of the two. The apparatus 1400 includes a second sending module 1410 and a second receiving module 1420.

The second sending module 1410 is configured to send configuration information of an SRS resource, where the SRS resource includes 8 antenna ports.

The second receiving module 1420 is configured to, on a physical resource corresponding to a transmission comb, simultaneously receive SRSs of the 8 antenna ports which are generated by respectively applying OCC to different SRS basic port sequences and sent.

In some examples, in a case that the physical resource is a physical resource corresponding to the same transmission comb, the SRSs of the 8 antenna ports include M×K=8 orthogonal sequences of the antenna ports generated by performing expansion by applying the OCC to basic port sequences corresponding to M antenna ports respectively. Where M is a positive integer not greater than 8, K is a sequence length of the OCC, and a value of K is 2, or 4 or 8.

In some examples, in a case of K=2, the SRSs of the 8 antenna ports include: 4×2=8 orthogonal sequences of the antenna ports generated by performing expansion by applying the OCC to basic port sequences corresponding to 4 antenna ports; and in a case of K=4, the SRSs of the 8 antenna ports include: 2×4=8 orthogonal sequences of the antenna ports generated by performing expansion by applying the OCC to basic port sequences corresponding to 2 antenna ports; and in a case of K=8, the SRSs of the 8 antenna ports include: 1×8=8 orthogonal sequences of the antenna ports generated by performing expansion by applying the OCC to a basic port sequence corresponding to 1 antenna port.

In some examples, the configuration information of the SRS resource includes at least one of the following: a transmission comb parameter K_{TC} of the transmission comb; a frequency domain offset value parameter k̅_{TC} of the transmission comb, where a value of k̅_{TC} is a non-negative integer less than K_{TC}; a time domain position of the transmission comb; the quantity of the antenna ports Nₐₚ^{SRS}=8; a cyclic shift parameter n_{SRS}^{cs}; or a sequence length K of the OCC.

In some examples, the second sending module 1410 is configured to: send one cyclic shift parameter configured for the SRS resource; or send M cyclic shift parameters configured for the SRS resource.

In some examples, the 8 antenna ports are divided into N antenna port groups, and each antenna port group includes 8/N antenna ports, where N is 2 or 4, and j is a positive integer not greater than N.

In a case that the physical resource is physical resources corresponding to N transmission combs, SRSs of the 8/N antenna ports corresponding to the j^{th} antenna port group include D×K=8/N orthogonal sequences of the antenna ports generated by performing expansion by applying the OCC to basic port sequences corresponding to D antenna ports in the j^{th} antenna port group respectively. Where D is an even number not greater than 8/N, K is a sequence length of the OCC, and a value of K is 2 or 4.

In some examples, the 8 antenna ports are divided into 2 antenna port groups, and each antenna port group includes 4 antenna ports; in a case of K=2, the SRSs of the 8/N antenna ports include: 2×2=4 orthogonal sequences of the antenna ports generated by performing expansion by applying the OCC to basic port sequences corresponding to 2 antenna ports in the j^{th} antenna port group; and in a case of K=4, the SRSs of the 8/N antenna ports include: 1×4=4 orthogonal sequences of the antenna ports generated by performing expansion by applying the OCC to a basic port sequence corresponding to 1 antenna port in the j^{th} antenna port group.

In some examples, the 8 antenna ports are divided into 4 antenna port groups, and each antenna port group includes 2 antenna ports; and in a case of K=2, the SRSs of the 8/N antenna ports include: 1×2=2 orthogonal sequences of the antenna ports generated by performing expansion by applying the OCC to a basic port sequence corresponding to 1 antenna port in the j^{th} antenna port group.

In some examples, the configuration information of the SRS resource includes at least one of the following: a transmission comb parameter K_{TC} of the transmission comb; a frequency domain offset value parameter k̅_{TC} of the transmission comb, where a value of k̅_{TC} is a non-negative integer less than K_{TC}; a time domain position of the transmission comb; the quantity of the antenna ports Nₐₚ^{SRS}=8; a cyclic shift parameter n_{SRS}^{cs}; a sequence length K of the OCC; and/or the quantity of the antenna port groups N, or, the quantity of the transmission combs N.

In some examples, the second sending module 1410 is configured to: send a first frequency domain offset value parameter of a transmission comb corresponding to a first antenna port group configured for the SRS resource, the first antenna port group being one of the N antenna port groups; or send frequency domain offset value parameters of transmission combs corresponding to the N antenna port groups configured for the SRS resource.

In some examples, the second sending module 1410 is configured to: send one cyclic shift parameter configured for the SRS resource; or send N cyclic shift parameters configured for the SRS resource.

In some examples, the transmission comb parameters K_{TC} of the transmission combs corresponding to the N antenna port groups are the same.

In some examples, the physical resources corresponding to the N transmission combs are different in frequency domain position and the same in time domain position; or, the physical resources corresponding to the N transmission combs are different in time domain position and the same in frequency domain position.

In some examples, the OCC is frequency domain OCC; or the OCC is time domain OCC.

In some examples, the N antenna port groups are obtained by sequential grouping of the 8 antenna ports according to port numbers; or the N antenna port groups are obtained by odd-even grouping of the 8 antenna ports according to port numbers; or the N antenna port groups are obtained by grouping the 8 antenna ports according to a combination manner predefined by a protocol; or the N antenna port groups are obtained by sequential grouping of the 8 antenna ports with odd port numbers to obtain at least two first antenna port groups, and sequential grouping of the 8 antenna ports with even port numbers to obtain at least two second antenna port groups.

In some examples, a function of the SRS resource is one of the following: a codebook; antenna switching; or a non-codebook.

FIG. 16 shows a schematic structural diagram of UE 1600 provided by an example of the disclosure. The UE 1600 includes: a processor 111, a receiver 112, a transmitter 113, a memory 114 and a bus 115.

The processor 111 includes one or more processing cores, and the processor 111 executes various functional applications and information processing by running software programs and modules, including but not limited to the first receiving module 1310, the second receiving module 1420, the first sending module 1320 and the second sending module 1410.

The receiver 112 and the transmitter 113 may be implemented as a communication component, which may be a communication chip, an input/output (I/O) device, or the like.

The memory 114 is connected with the processor 111 through the bus 115. The bus 115 connects communicatively or otherwise the processor 111, receiver 112, transmitter 113, and memory 114.

The memory 114 may be configured to store at least one instruction, and the processor 111 is configured to execute the at least one instruction to implement various steps in the method examples for sending or receive an SRS.

In addition, the memory 114 may be implemented by any type of volatile or nonvolatile storage device or their combinations, the volatile or nonvolatile storage device includes but is not limited to: a magnetic disk or an optic disk, an electrically erasable programmable read only memory (EEPROM), an erasable programmable read only memory (EPROM), a static random-access memory (SRAM), a read only memory (ROM), a magnetic memory, a flash memory, and a programmable read only memory (PROM).

In an example, a non-transitory computer-readable storage medium including instructions, such as the memory including instructions, which can be executed by the processor 111 of the UE 1600 to complete any of the methods for sending or receiving an SRS, is also provided. For example, the non-temporary computer-readable storage medium may be a ROM, a random-access memory (RAM), a compact disc read only memory (CD-ROM), magnetic tape, a floppy disk, an optical data storage device, etc.

A non-transitory computer-readable storage medium is provided, and instructions in the non-transitory computer storage medium, when executed by a processor 111 of UE 1600, cause the UE 1600 to execute any of the methods for sending or receiving an SRS.

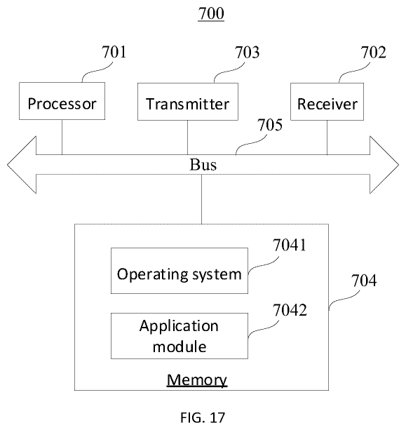

FIG. 17 is a block diagram of a network device 700 shown according to an example. The network device 700 may be a base station.

The network device 700 may include: a processor 701, a receiver 702, a transmitter 703 and a memory 704. The receiver 702, the transmitter 703 and the memory 704 are connected with the processor 701 through a bus 705.

The processor 701 includes one or more processing cores, and the processor 701 executes a method executed by the network device in the method for receiving an SRS provided by the example of the disclosure by running software programs and modules, including but not limited to the first receiving module 1310, the second receiving module 1420, the first sending module 1320 and the second sending module 1410. The memory 704 may be configured to store the software programs and the modules, including but not limited to the first receiving module 1310, the second receiving module 1420, the first sending module 1320 and the second sending module 1410. Specifically, the memory 704 may store an operating system 7041 and an application module 7042 needed by at least one function. The receiver 702 is configured to receive communication data sent by other devices, and the transmitter 703 is configured to send communication data to other devices.

An example of the disclosure further provides a non-transitory computer-readable storage medium, the non-transitory computer-readable storage medium stores at least one of at least one instruction, at least one program, a code set or an instruction set, and the at least one instruction, the at least one program, the code set or the instruction set is loaded and executed by a processor to implement the method for sending an SRS or the method for receiving an SRS provided by any of the various method examples.

An example of the disclosure further provides a computer program product, the computer program product includes computer instructions, and the computer instructions are stored in a non-transitory computer-readable storage medium; and a processor of a computer device reads the computer instructions from the non-transitory computer-readable storage medium, and the processor executes the computer instructions to cause the computer device to execute the method for sending an SRS or the method for receiving an SRS provided by any of the various method examples.

It is to be understood that, “a plurality of” referred to here refers to two or more. “And/or” describes an association relationship of associated objects, which means that there can be three kinds of relationships, for example, A and/or B can mean that there are three kinds of situations: A alone, A and B at the same time, and B alone. The character “/” universally indicates that front and back associated objects are in an “or” relationship.

Other implementation schemes of the disclosure will be apparent to those skilled in the art from consideration of the specification and practice of the disclosure here. The disclosure is intended to cover any variations, uses, or adaptations of the disclosure, and these variations, uses, or adaptations follow the general principles of the disclosure and include such departures from the disclosure as come within known or customary practice in the art. It is intended that the specification and examples be considered as exemplary merely, with a true scope and spirit of the disclosure being indicated by the claims.

It will be appreciated that the disclosure is not limited to the exact construction that has been described herein and illustrated in the accompanying drawings, and that various modifications and changes may be made without departing from the scope of the disclosure. It is intended that the scope of the disclosure is merely limited by the appended claims.

1. A method for sending a sounding reference signal (SRS), performed by a terminal, comprising:
receiving configuration information of an SRS resource, wherein the SRS resource comprises 8 antenna ports; and
mapping the SRS resource onto a physical resource corresponding to a configured transmission comb, and generating and sending SRSs of the 8 antenna ports by respectively applying an orthogonal cover code (OCC) to different SRS basic port sequences.

2. The method according to claim 1, wherein
mapping the SRS resource onto the physical resource corresponding to the configured transmission comb comprises:
mapping the SRS resource onto a physical resource corresponding to a same transmission comb; and
generating and sending the SRSs of the 8 antenna ports by respectively applying the OCC to the different SRS basic port sequences comprises:
performing expansion by applying the OCC to basic port sequences corresponding to M antenna ports respectively, and generating and sending M×K=8 orthogonal sequences of the antenna ports; wherein
M is a positive integer not greater than 8, K is a sequence length of the OCC, and a value of K is 2, or 4, or 8.

3. The method according to claim 2, wherein performing the expansion by applying the OCC to basic port sequences corresponding to M antenna ports respectively, and generating and sending M×K=8 orthogonal sequences of the antenna ports comprises one of:
performing, in a case of K=2, expansion by applying the OCC to basic port sequences corresponding to 4 antenna ports respectively, and generating and sending 4×2=8 orthogonal sequences of the antenna ports;
performing, in a case of K=4, expansion by applying the OCC to basic port sequences corresponding to 2 antenna ports respectively, and generating and sending 2×4=8 orthogonal sequences of the antenna ports; or
performing, in a case of K=8, expansion by applying the OCC to a basic port sequence corresponding to 1 antenna port, and generating and sending 1×8=8 orthogonal sequences of the antenna ports.

4. The method according to claim 2, wherein the configuration information of the SRS resource comprises at least one of the following:
a transmission comb parameter K_{TC} of the transmission comb;
a frequency domain offset value parameter k_{TC} of the transmission comb, wherein a value of k_{TC} is a non-negative integer less than K_{TC};
a time domain position of the transmission comb;
the quantity of the antenna ports Nₐₚ^{SRS}=8;
a cyclic shift parameter n_{SRS}^{cs}; or
a sequence length K of the OCC.

5. The method according to claim 4, wherein
receiving the configuration information of the SRS resource comprises:
receiving one cyclic shift parameter configured for the SRS resource; and
the method further comprises:
generating M basic port sequences corresponding to the M antenna ports based on the cyclic shift parameter.

6. The method according to claim 4, wherein
receiving the configuration information of the SRS resource comprises:
receiving M cyclic shift parameters configured for the SRS resource; and
the method further comprises:
generating M basic port sequences corresponding to the M antenna ports based on the M cyclic shift parameters.

7. The method according to claim 1, wherein
the 8 antenna ports are divided into N antenna port groups, each antenna port group comprises 8/N antenna ports, and N is 2 or 4;
mapping the SRS resource onto the physical resource corresponding to the configured transmission comb comprises:
mapping the SRS resources of the N antenna port groups onto physical resources corresponding to N transmission combs; and
generating and sending the SRSs of the 8 antenna ports by respectively applying the OCC to the different SRS basic port sequences comprises:
performing expansion by applying the OCC to each of the different SRS basic port sequences corresponding to D antenna ports in the j^{th} antenna port group respectively, and generating and sending D×K=8/N orthogonal sequences of the antenna ports; wherein
D is an even number not greater than 8/N, K is a sequence length of the OCC, a value of K is 2 or 4, and j is a positive integer not greater than N.

8. The method according to claim 7, wherein
the 8 antenna ports are divided into 2 antenna port groups, and each antenna port group comprises 4 antenna ports; and
performing the expansion by applying the OCC to each of the different SRS basic port sequences corresponding to the D antenna ports in the j^{th} antenna port group respectively, and generating and sending D×K=8/N orthogonal sequences of the antenna ports comprises one of:
performing, in a case of K=2, expansion by applying the OCC to basic port sequences corresponding to 2 antenna ports in the j^{th} antenna port group respectively, and generating and sending 2×2=4 orthogonal sequences of the antenna ports; or
performing, in a case of K=4, expansion by applying the OCC to a basic port sequence corresponding to 1 antenna port in the j^{th} antenna port group, and generating and sending 1×4=4 orthogonal sequences of the antenna ports.

9. The method according to claim 7, wherein
the 8 antenna ports are divided into 4 antenna port groups, and each antenna port group comprises 2 antenna ports; and
performing the expansion by applying the OCC to each of the different SRS basic port sequences corresponding to the D antenna ports in the j^{th} antenna port group respectively, and generating and sending D×K=8/N orthogonal sequences of the antenna ports comprises:
performing, in a case of K=2, expansion by applying the OCC to a basic port sequence corresponding to 1 antenna port in the j^{th} antenna port group, and generating and sending 1×2=2 orthogonal sequences of the antenna ports.

10. The method according to claim 7, wherein the configuration information of the SRS resource comprises at least one of the following:
a transmission comb parameter K_{TC} of the transmission comb;
a frequency domain offset value parameter k_{TC} of the transmission comb, wherein a value of k_{TC} is a non-negative integer less than K_{TC};
a time domain position of the transmission comb;
the quantity of the antenna ports Nₐₚ^{SRS}=8;
a cyclic shift parameter n_{SRS}^{cs};
a sequence length K of the OCC; or
the quantity of the antenna port groups N, or, the quantity of the transmission combs N.

11. The method according to claim 10, wherein
receiving the configuration information of the SRS resource comprises:
receiving a first frequency domain offset value parameter of a transmission comb corresponding to a first antenna port group configured for the SRS resource, the first antenna port group being one of the N antenna port groups; and
the method further comprises:
calculating other frequency domain offset value parameters of transmission combs corresponding to other antenna port groups based on the first frequency domain offset value parameter, the other antenna port groups being one of the N antenna port groups other than the first antenna port group.

12. The method according to claim 10, wherein receiving the configuration information of the SRS resource comprises:
receiving frequency domain offset value parameters of transmission combs corresponding to the N antenna port groups configured for the SRS resource.

13. The method according to claim 10, wherein
receiving the configuration information of the SRS resource comprises:
receiving one cyclic shift parameter configured for the SRS resource; and
the method further comprises:
generating D basic port sequences corresponding to all the D antenna ports in each antenna port group based on the cyclic shift parameter.

14. The method according to claim 10, wherein
receiving the configuration information of the SRS resource comprises:
receiving N cyclic shift parameters configured for the SRS resource; and
the method further comprises:
generating D basic port sequences corresponding to all the D antenna ports in each antenna port group based on the N cyclic shift parameters.

15-16. (canceled)

17. The method according to claim 7, wherein
the N antenna port groups are obtained by sequential grouping of the 8 antenna ports according to port numbers; or
the N antenna port groups are obtained by odd-even grouping of the 8 antenna ports according to port numbers; or
the N antenna port groups are obtained by grouping the 8 antenna ports according to a combination manner predefined by a protocol; or
the N antenna port groups are obtained by sequential grouping of the 8 antenna ports with odd port numbers to obtain at least two first antenna port groups, and sequential grouping of the 8 antenna ports with even port numbers to obtain at least two second antenna port groups.

18. The method according to claim 2, wherein after generating the M×K=8 orthogonal sequences of the antenna ports, the method comprises:
mapping the 8 generated orthogonal sequences to the 8 antenna ports sequentially according to a sequence of applying the OCC to the basic port sequences in a case of M=1; and
mapping the 8 generated orthogonal sequences to the 8 antenna ports sequentially according to a sequence of applying the OCC to the basic port sequences after the basic port sequences are ranked according to the cyclic shift parameters from small to large in a case of M>1.

19. The method according to claim 7,
wherein after generating the D×K=8/N orthogonal sequences of the antenna ports, the method comprises:
mapping the 8/N generated orthogonal sequences to the 8/N antenna ports in the j^{th} antenna port group sequentially according to a sequence of applying the OCC to the basic port sequence in a case that the j^{th} antenna port group corresponds to one basic port sequence; and
mapping the 8/N generated orthogonal sequences to the 8/N antenna ports in the j^{th} antenna port group sequentially according to a sequence of applying the OCC to the basic port sequences after the basic port sequences are ranked according to the cyclic shift parameters from small to large in a case that the j^{th} antenna port group corresponds to D basic port sequences.

20-21. (canceled)

22. A method for receiving a sounding reference signal (SRS), performed by a network device, comprising:
sending configuration information of an SRS resource, wherein the SRS resource comprises 8 antenna ports; and
on a physical resource corresponding to a transmission comb, simultaneously receiving SRSs of the 8 antenna ports which are generated and sent by respectively applying an orthogonal cover code (OCC) to different SRS basic port sequences.

23-39. (canceled)

40. A terminal, comprising:
one or more processors; and
one or more transceivers connected with the one or more processors; wherein the one or more processors are configured to;
receive configuration information of a sounding reference signal (SRS) resource, wherein the SRS resource comprises 8 antenna ports; and
map the SRS resource onto a physical resource corresponding to a configured transmission comb, and generate and send SRSs of the 8 antenna ports by respectively applying an orthogonal cover code (OCC) to different SRS basic port sequences.

41. A network device, comprising:
one or more processors; and
one or more transceivers connected with the one or more processors; wherein
the one or more processors are configured to load and execute executable instructions to implement the method for receiving the SRS according to claim 22.

42-43. (canceled)
